(19) United States
(12) Patent Application Publication
(10) Pub. No.: US 2015/0006412 A1
(43) Pub. Date: Jan. 1, 2015

(54) METHOD OF COLLECTING DATA FROM COMMUNITY ASSOCIATIONS

(71) Applicant: Robert Tankel, Dunedin, FL (US)

(72) Inventor: Robert Tankel, Dunedin, FL (US)

(21) Appl. No.: 14/320,468

(22) Filed: Jun. 30, 2014

Related U.S. Application Data
(60) Provisional application No. 61/841,409, filed on Jun. 30, 2013.

(51) Int. Cl. G06Q 50/16

(52) U.S. Cl. CPC G06Q 50/16
USPC 705/313

(57) ABSTRACT

A method of collecting data from community associations, including documents that are publicly available as well as internal documentation, can involve scanning the information into a searchable format. Certain key words can be used to search the documents to help determine which, if any, legal issues presented, by a review of the context of the search, may be material to a purchaser and such issues can be highlighted for consideration. The method solves the problem of lack of information involved in the purchase of real property by gathering all available documentation, scanning it for key words and phrases that may be relevant to the purchase price and presenting results in lay terms so purchasers can determine if a particular home in a particular community is suitable or whether the information provided makes a material difference in an offering price. The present invention can also serve as a digital document depository.

### CROSS-REFERENCE TO RELATED APPLICATION

This application claims the benefit of priority of U.S. provisional application No. 61/841,409, filed Jun. 30, 2013, the contents of which are herein incorporated by reference.

### BACKGROUND OF THE INVENTION

The present invention relates to methods for collecting data from community associations and, more particularly, to a method of collecting data from community associations that includes documents that are publicly available as well as internal documentation. The information can be scanned or otherwise uploaded for review and if needed, changed into a searchable format. Certain keywords can be used to search the documents to help determine which, if any, legal issues, presented by a review of the context of the of the search, may be material to a purchaser highlighted for consideration, as well as human application of proprietary criteria for determining what information is potentially useful to a consumer of such information, and the distilling it into lay terms so as to be understood by potential renters and purchasers.

In the past 50 years, the proliferation of Common ownership interest communities, such as condominiums, cooperatives and homeowner's associations, has exploded. One estimate is that over 50 million people own in such developments. The documents creating and determining the operation of such communities makes it nearly impossible for a lay person to understand the organizational setup of such a community, let alone identify and quantify the issues that may be material to the investment that is contemplated.

In the purchase of real property, the purchasers and sellers are either unaware of what information is available or how to read and digest it. Information can be difficult to come by for the average seller and buyer. When obtained, it is difficult to understand. Most people don't want to pay for review of documents that are found and those reviewing the documents may not even have expertise in the field to read and analyze the available information.

Raw data, such as financial reports, minutes of meetings, litigation dockets, use restriction enforcement reports and contracts are currently available. No programs or processes are known to exist to analyze that information, determine what parts of it may vary from a mean or median type of community, and identify outlier ongoing events potentially material to a purchase.

As can be seen, there is a need for method of collecting data from community associations that includes documents that are publicly available as well as internal documentation.

### SUMMARY OF THE INVENTION

In one aspect of the present invention, a method for providing data to a potential purchaser of real property comprises obtaining digital records into a computer system; searching, by the computer system, the digital records for key words; and processing the searched digital records to bring attention to areas of potential concern to the potential purchaser.

In another aspect of the present invention, a method for providing data to a potential purchaser of real property comprises obtaining digital records into a computer system; searching, by the computer system, the digital records for key words; processing the searched digital records to bring attention to areas of potential concern to the potential purchaser; analyzing and removing legalese, by the computer system, to increase the user friendliness to the potential purchaser; displaying the digital records on a computer system for editing by a user; and electronically delivering the processed, searched and edited digital records to a central repository for later distribution.

These and other features, aspects and advantages of the present invention will become better understood with reference to the following drawings, description and claims.

### BRIEF DESCRIPTION OF THE DRAWINGS

FIG. 1 is a schematic representation of a condominium-type of property ownership;

FIG. 2 is a schematic representation of a home owner's association (HOA) type of property ownership; and

FIG. 3 is a schematic flow chart depicting a method according to an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a method of collecting data from community associations that includes documents that are publicly available as well as internal documentation. The information can be scanned into a searchable format and certain key words will search the documents to help determine which, if any, legal issues presented, by a review of the context of the search, may be material to a purchaser and highlighted for consideration. The method of the present invention solves the problem of lack of information involved in the purchase of real property. The method of the present invention gathers all available documentation, scans it for key words and phrases that may be relevant to the purchase price and presents it in lay terms so purchasers can determine if a particular home in a particular community is suitable or whether the information provided makes a material difference in an offering price. The present invention can serve as a digital document depository and can be useful, for example, for storage and retrieval of required records for corporations.

The methods of the present invention provide a gain in transparency in an asset sale and purchase. The ability to determine whether information is material can be easily ascertained well before a contract is executed. The methods of the present invention remove the opacity of determining what information is material and what is not, and allow purchasers of homes in community associations the opportunity to quickly and inexpensively make decisions about the legal and financial status of the community before even visiting.

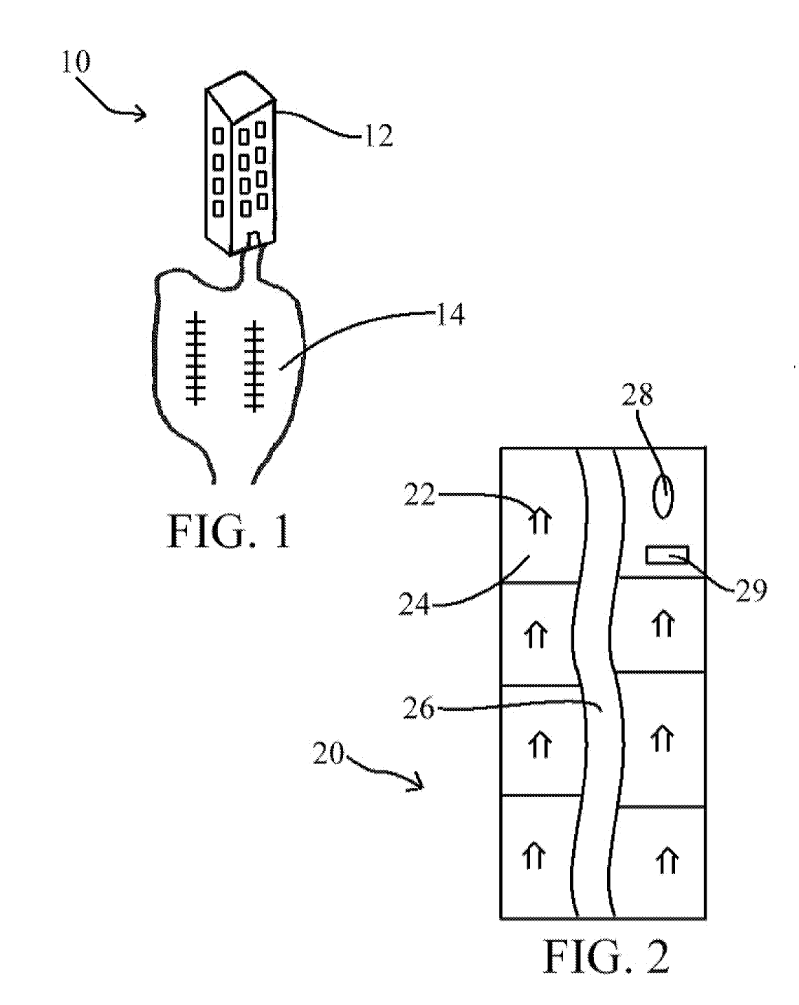

The methods of the present invention can be used in various situations, such as in co-operatives (co-ops), condominiums 10, as shown in FIG. 1, and in homeowner's associations 20, as illustrated in FIG. 2. Prior to making a purchase of a condominium, various documents may be available involving the building 12 and the grounds 14 that may provide limitations and restrictions on owners or shareholders. Additionally, when buying a home 22 or property 24 in an area governed by a homeowner's association, there may be various documents, covenants and other agreements that govern what land owners in the homeowner's association can and cannot do. These documents may regulate the property 24, aspects of the home 22, the road 26 and various community features, such as pools 28 and/or tennis courts 29.

The methods of the present invention may also be used in other situations, such as for corporations to provide storage and retrieval of documentation required by the state's corporation laws.

The methods of the present invention, in addition to scanning documents and the like, can obtain data from other sources, such as internet web sites, law enforcement agencies, and the like. This information may be useful, for example, to provide data on registered sex offenders, recent sales, and the like.

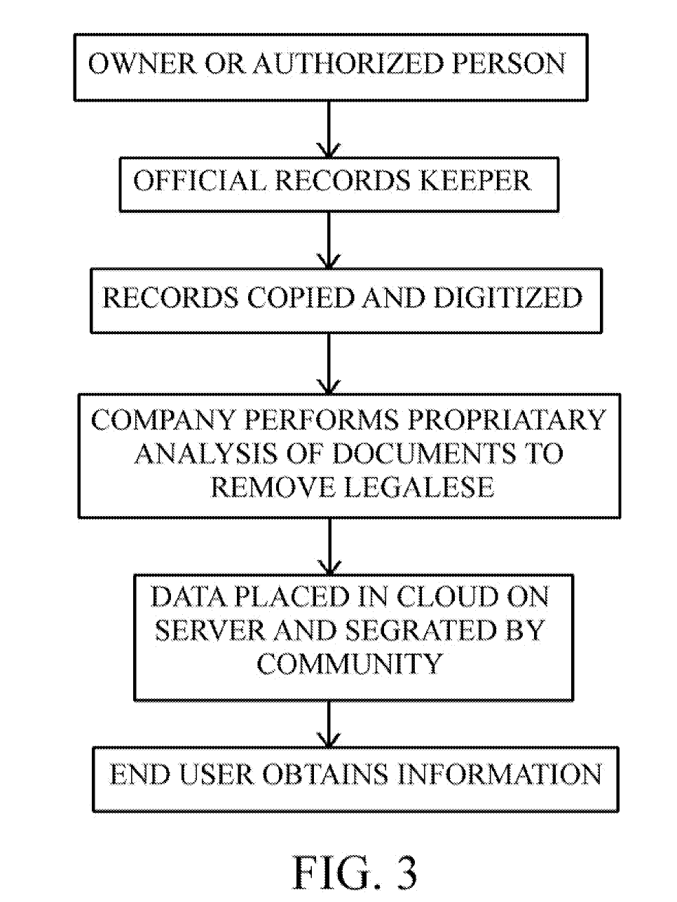

In an exemplary embodiment of the present invention, a method includes a step of determining the type of residential ownership community. This could be, for example, a condominium, a home owner's association, or the like. Next, the method seeks corporate, accounting, budgeting and legal documentation of the community. Once determined, the method requests and obtains access to the records such as by obtaining copies or electronic files, which are digitized into a computer system. The digitized documents are then processed by looking for key words to highlight potential areas of concern to allow the method of the present invention to draw attention to those areas. The processing can include an analysis to remove legalese and make the documents more user friendly for the end user. The end documents and the analysis can be placed, for example, on a cloud or on a server for later distribution. A graphical user interface (GUI) can be provided to interface with the documents by locale and a system can be set up to allow the purchase and/or access to the data by the end user. FIG. 3 shows a schematic representation of this process.

In greater detail, the methods of the present invention includes steps of gathering of the information, which requires access to the corporate, legal and financial documents of a condominium or homeowners association. The information can then be delivered to a processing facility in a digital format. Software can then be used to analyze the contents of the documents and detail points of interest before a human interacts with the information. The document is then analyzed by trained people who can interpret the information provided, and explain the information gathered in layman's terms. After the analysis is complete, it can be reassembled into a package suitable for delivery in either HTML or downloadable format, as well as hard copy delivery by mail or other hard copy delivery services to a customer for use in connection with determining whether to proceed further with a potential lease or purchase of the property.

The documents obtained are processed to extract words and phrases which are then used to call attention to particular aspects of the operation and legal, financial and operational status of the community. This involves application of OCR software and determining the incidences of the predetermined words and phrases to call attention to a particular document in order to analyze it further and use a proprietary method to explain the meaning of the document and how it might apply to the potential selection of a particular property in a particular community to proceed with the purchase thereof.

The information obtained by the above process can then be developed into a web interface for ordering and delivering the finished product, complete with analysis and the underlying raw documents.

The methods of the present invention provide information to consumers online. This information is made available for purchase on an a la carte basis for the raw documents, or to potential purchasers as a proprietary package of information prior to contract deposits. The information provides a purchaser with a concise set of standards that can be used for analyzing the information that is provided in order to determine whether the community is in legal, financial, governmental or other trouble. This information is not readily apparent or available, but can be obtained by analyzing the documents that will be provided. The methods of the present invention can save the potential purchaser's hours of traveling and obtaining the information. Moreover, it will provide the information in a concise and easy-to-understand format. The product is different from conventional information systems because no real estate agent, title agent, lawyer or seller generally has the ability to provide all of the information on a cost-effective bases without liability because all of such information is practically undecipherable without the rubric needed to understand the information and separate the “wheat from the chaff” in the documents that govern the community.

In some embodiments of the present invention, certain parts of the analysis might be excluded, offering non-analyzed, “dumb” documents for purchasers who wish to perform their own due diligence and analysis, perhaps for a reduced price. In some embodiments, elements could be added to the present invention, for example, in the form of advertising to lead the consumers of the information to real estate professionals, lenders, title companies, insurance and others related in the process. If relocating to a new community links to area sites of interest, schools, places of worship, shopping, transit and the like, could all be added. The essential documents and analysis thereof could be stripped from the products available so as to simply provide information about the neighborhood, community and service providers in the area where relocation will occur.

It should be understood, of course, that the foregoing relates to exemplary embodiments of the invention and that modifications may be made without departing from the spirit and scope of the invention as set forth in the following claims.

What is claimed is:

1. A method for providing data to a potential purchaser of real property, comprising:
obtaining digital records into a computer system;
searching, by the computer system, the digital records for key words; and
processing the searched digital records to bring attention to areas of potential concern to the potential purchaser.

2. The method of claim 1, wherein the digital records include corporate, accounting, budgeting and legal documentation of a community in which the real property is located.

3. The method of claim 1, wherein the digital records are documents related to a condominium or homeowners association.

4. The method of claim 1, further comprising analyzing and removing legalese, by the computer system, to increase the user friendliness to the potential purchaser.

5. The method of claim 1, further comprising electronically delivering the processed and searched digital records to a central repository for later distribution.

6. The method of claim 5, wherein the central repository is a computer server database.

7. The method of claim 6, wherein the computer server database is a cloud-based computer server database.

8. The method of claim 1, further comprising permitting access to the processed and searched digital records via a graphical user interface.

9. The method of claim 1, wherein the digital records are obtained by scanning paper records into the computer system.

10. The method of claim 9, further comprising performing online character recognition on the scanned paper records.

11. The method of claim 1, further comprising displaying the digital records on a computer system for editing by a user.

12. The method of claim 11, further comprising preparing a document package of containing at least portions of digital information and user edited information for the potential purchaser.

13. A method for providing data to a potential purchaser of real property, comprising:
obtaining digital records into a computer system;
searching, by the computer system, the digital records for key words;
processing the searched digital records to bring attention to areas of potential concern to the potential purchaser;
analyzing and removing legalese, by the computer system, to increase the user friendliness to the potential purchaser;
displaying the digital records on a computer system for editing by a user; and
electronically delivering the processed, searched and edited digital records to a central repository for later distribution.

14. The method of claim 13, wherein the digital records include corporate, accounting, budgeting and legal documentation of a community in which the real property is located.

15. The method of claim 13, wherein the digital records are documents related to a condominium or homeowners association.

16. The method of claim 13, further comprising permitting access to the processed and searched digital records via a graphical user interface.

17. The method of claim 13, wherein the digital records are obtained by scanning paper records into the computer system.

18. The method of claim 13, wherein the digital records include publicly available information pertaining to the property, a community, and an area surrounding the community.
